(19) United States
(12) Patent Application Publication
(10) Pub. No.: US 2023/0151739 A1
(43) Pub. Date: May 18, 2023

(54) BRUSH SEAL COMPRISING A RUBBING-TOLERANT SUPPORT RING STRUCTURE

(71) Applicant: MTU Aero Engines AG, Munich (DE)

(72) Inventors: Jan Versluis, Munich (DE); Johann Goettler, Munich (DE); Tobias Klausmann, Munich (DE); Stefan Beichl, Munich (DE)

(21) Appl. No.: 18/055,848

(22) Filed: Nov. 16, 2022

(30) Foreign Application Priority Data
Nov. 17, 2021 (DE) 102021129985.3

(51) Int. Cl. F01D 11/12; F01D 25/24

(52) U.S. Cl. CPC F01D 11/12; F01D 25/24; F05D 2240/14; F05D 2250/324; F05D 2240/56

(57) ABSTRACT

A brush seal can be used for a gas turbine. The brush seal includes a support ring structure; and at least one bundle of bristles that is arranged in an axial direction on the support ring structure. The support ring structure has a basis portion arranged radially on the outside, and a supporting portion arranged radially on the inside. The supporting portion has a supporting surface that faces the bundle of bristles and supports the bundle of bristles in the axial direction. The supporting portion has a radially inner edge portion that faces a rotor portion of the gas turbine when the brush seal is in an assembled state. Starting from the radially inner edge portion, the supporting portion has a radial supporting-portion length together with a substantially constant axial supporting-portion width, the supporting-portion length being greater than the supporting-portion width by at least a factor of four.

### STATEMENT REGARDING SPONSORED RESEARCH OR DEVELOPMENT

The work leading to this invention was funded in accordance with Grant Agreement No. CS2-ENG-GAM-2014-2015-01 in the course of the European Union's Seventh Framework Programme (FP7/2007-2013) for the Clean Sky Joint Technology Initiative.

### CROSS REFERENCE TO RELATED APPLICATIONS

This application claims benefit to German Patent Application No. DE 102021129985.3, filed on Nov. 17, 2021, which is hereby incorporated by reference herein.

### FIELD

The present disclosure relates to a brush seal for a gas turbine, in particular an aircraft gas turbine, having a support ring structure.

### BACKGROUND

Currently, a support ring structure or support ring of a brush seal for a gas turbine is configured such that there is no contact with the rotating part or rotor portion of the sealing system while the gas turbine is in operation. The diameter of the support ring, or of the rotating part or rotor portion, is thus selected so that the two components are prevented from rubbing against each other, as any such rubbing would cause damage to the rotating part or rotor portion. If a radial and/or axial relative movement of the rotor portion and support ring structure in a gas turbine is or becomes greater, a larger diameter of the support ring structure or support ring has to be selected accordingly. In the process, a large gap between the support ring and the rotor portion leads to a larger leakage surface area of the bundle of bristles. In addition, when the support ring has a larger diameter, the wire overhang of the bundle of bristles at the radially inner edge of said support ring becomes larger, as a result of which the “blow-over effect” of the bundle of bristles (bending of bristles underneath the support ring) occurs sooner. Consequently, a brush seal of this kind cannot be used in as many applications, or a bundle of bristles having greater axial rigidity has to be used. The latter option, however, has drawbacks in terms of the admission of heat and abrasive wear.

For the design of various brush seals, reference is made, by way of example, to the following documents: EP 0 453 315 B1, U.S. Pat. Nos. 5,308,088 A, 5,351,871 A, 7,461,847 B2, 6,471,212 B1, and 10,024,192 B2.

### SUMMARY

In an embodiment, the present disclosure provides a brush seal that can be used for a gas turbine. The brush seal includes a support ring structure; and at least one bundle of bristles that is arranged in an axial direction on the support ring structure. The support ring structure has a basis portion arranged radially on the outside, and a supporting portion arranged radially on the inside. The supporting portion has a supporting surface that faces the bundle of bristles and supports the bundle of bristles in the axial direction. The supporting portion has a radially inner edge portion that faces a rotor portion of the gas turbine when the brush seal is in an assembled state. Starting from the radially inner edge portion, the supporting portion has a radial supporting-portion length together with a substantially constant axial supporting-portion width, the supporting-portion length being greater than the supporting-portion width by at least a factor of four.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic representation of the general structure of an aircraft gas turbine;

FIG. 2 is a schematic sectional view of an example of a brush seal;

FIG. 3 is a schematic sectional view of a further example of a brush seal; and

FIG. 4 is a schematic sectional view of a further example of a brush seal.

### DETAILED DESCRIPTION

Aspects of the present disclosure provide a brush seal in which the above drawbacks can be avoided.

According to an aspect of the present disclosure, a brush seal for a gas turbine, in particular an aircraft gas turbine, is provided. The brush seal may include a support ring structure and at least one bundle of bristles that is arranged in the axial direction on the support ring structure, the support ring structure having a basis portion arranged radially on the outside and a supporting portion arranged radially on the inside, the supporting portion having a supporting surface which faces the bundle of bristles and supports the bundle of bristles in the axial direction, and the supporting portion having a radially inner edge portion that faces a rotor portion of the gas turbine when the brush seal is in an assembled state. According to an aspect of the present disclosure, starting from the radially inner edge portion, the supporting portion has a radial supporting-portion length together with a substantially constant axial supporting-portion width, the supporting-portion length being greater than the supporting-portion width by at least a factor of four.

A configuration of this kind provides a support ring that does not cause critical damage to the rotating component or rotor portion if any rubbing occurs. In other words, the support ring is configured to be significantly thinner at its radially inner supporting portion in order to ensure that the damage to the rotor portion is minimized in the event of rubbing. The supporting portion or support ring structure can thus also be described as being rubbing-tolerant. Despite its minimized axial supporting-portion width compared with known support rings, in conventional areas of operation of a gas turbine the support ring takes on the sealing action and also the action of supporting the bundle of bristles.

In the brush seal, a transitional portion may adjoin the supporting portion radially on the outside, which transitional portion has at least one curve contour that diverges from the radial direction. By means of a curve contour of this kind, forces acting on the relatively thin supporting portion in the axial direction can be optimally transmitted to the support ring structure or basis portion without any undesirable peak stresses occurring in the transition region, which poses a risk of cracks forming.

In the process, the transitional portion may have an axial transitional width that is greater than the supporting-portion width. The axial transitional width may also increase in the radial direction either constantly or discretely.

In the brush seal, the supporting portion, the transitional portion, and the basis portion of the support ring structure may be formed in one piece. In particular, in this case the support ring structure may be manufactured as a turned part, a sheet metal part, or additively.

Alternatively, in the brush seal the supporting portion and the transitional portion may be configured as a single-piece supporting element that is connected to the basis portion of the support ring structure. In particular, in this case the support ring structure may be manufactured or formed by two sheet metal parts.

In the brush seal, the supporting-portion length may be greater than the supporting-portion width by at most a factor of twenty. In particular, the supporting-portion length may be greater than the supporting-portion width by a factor of five to fifteen.

In the brush seal, the supporting-portion length may be approximately 1 mm to 4 mm, in particular 2 mm to 3 mm, and the supporting-portion width may be approximately 0.1 mm to 0.8 mm, in particular 0.2 mm to 0.6 mm.

The brush seal may have a cover ring structure, the bundle of bristles being received between the cover ring structure and the support ring structure in the axial direction.

According to an aspect of the present disclosure, a gas turbine, in particular an aircraft gas turbine, is also provided. The gas turbine may include at least one above-described brush seal surrounding a rotor portion of the gas turbine. In particular, the brush seal can be used in the region of a low-pressure turbine. Other installation sites in the gas turbine are also conceivable, for example the high-pressure compressor and the like.

In the gas turbine, the rotor portion surrounded by the brush seal may have, in a rubbing region facing the brush seal, a radial rotor-portion thickness that is greater than the radial rotor thickness outside the rubbing region. A wall thickness of the rotor portion is greater in the rubbing region so that the rotor is designed to be more robust against any potential rubbing by the supporting portion.

Alternatively or additionally, in the gas turbine the rotor portion may have a coating, located radially on the outside, in the rubbing region. In particular, a coating of this kind may be made of a material that is more resistant than the material from which the rotor portion is made.

Aspects of the present disclosure will now be described by way of example, and not by way of limitation, with reference to the accompanying drawings.

In the present disclosure directional words such as “axial,” “axially,” “radial,” “radially,” and “circumferential” should be taken with respect to the machine axis of the gas turbine, unless explicitly or implicitly indicated otherwise by the context.

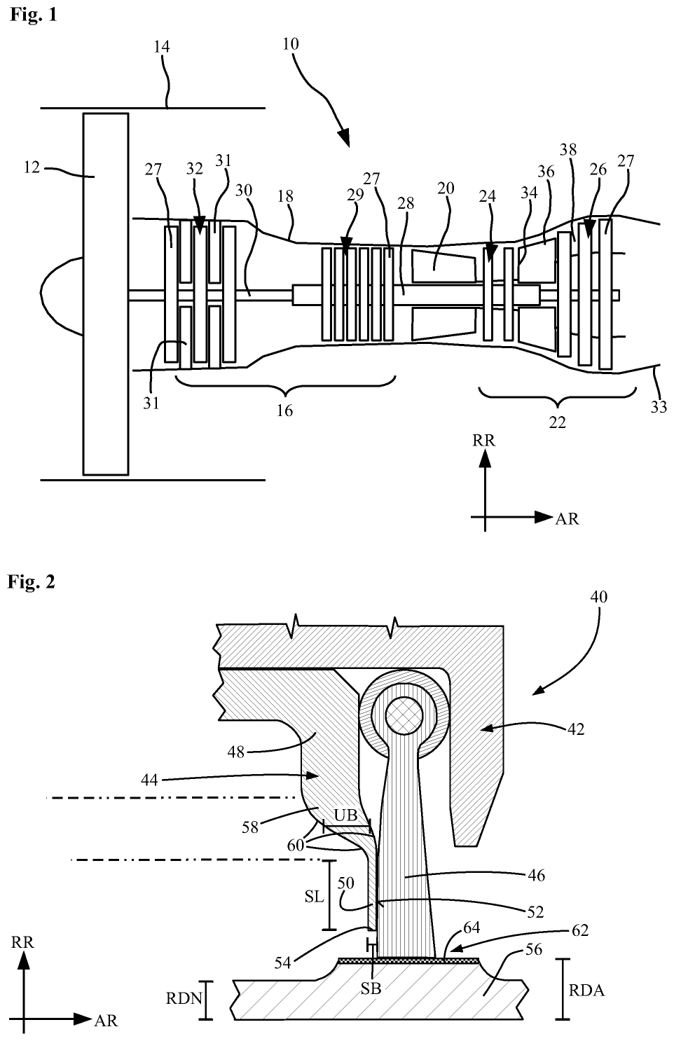

FIG. 1 is a schematic representation of an aircraft gas turbine 10, illustrated merely by way of example as a turbofan engine. The gas turbine 10 comprises a fan 12, which is surrounded by a schematically indicated duct 14. A compressor 16 adjoins the fan 12 in the axial direction AR of the gas turbine 10 and is received in a schematically indicated inner casing 18 and may be single-stage or multi-stage. The combustor 20 adjoins the compressor 16. Hot exhaust gas flowing out of the combustor then flows through the adjoining turbine 22, which may be single-stage or multi-stage. In this example, the turbine 22 comprises a high-pressure turbine 24 and a low-pressure turbine 26. A hollow shaft 28 connects the high-pressure turbine 24 to the compressor 16, in particular a high-pressure compressor 29, such that they are jointly driven or rotated. A shaft 30 located further inward in the radial direction RR of the turbine connects the low-pressure turbine 26 to the fan 12 and to a low-pressure compressor 32 such that they are jointly driven or rotated. Adjoining the turbine 22 is an exhaust nozzle 33, which is only schematically indicated here.

In the illustrated example of an aircraft gas turbine 10, a turbine center frame 34 is arranged between the high-pressure turbine 24 and the low-pressure turbine 26 and arranged around the shafts 28, 30. Hot exhaust gases from the high-pressure turbine 24 flow through the turbine center frame 34 in its radially outer region 36. The hot exhaust gas then flows into an annular space 38 in the low-pressure turbine 26. The compressors 28, 32 and turbines 24, 26 are represented, by way of example, by rotor blade rings 27. For the sake of clarity, the usually present stator vane rings 31 are shown, by way of example, only for the compressor 32.

Examples of brush seals which can be inserted or arranged in particular in the region of a turbine 22, in particular a low-pressure turbine 26, or a compressor 16, in particular a high-pressure compressor 29, will be described in the following.

FIG. 2 is a simplified and schematic sectional view of a brush seal 40. The brush seal 40 comprises a cover ring structure 42, which can also be referred to simply as a cover ring 42. In addition, the brush seal 40 has a support ring structure 44, which in simpler terms can also be referred to as a support ring. A bundle of bristles 46 is arranged or received between the cover ring structure 42 and the support ring structure 44 in the axial direction AR.

The support ring structure 42 has a basis portion 48 arranged radially on the outside and a supporting portion 50 arranged radially on the inside. The supporting portion 50 has a supporting surface 52 that faces the bundle of bristles 46 and supports the bundle of bristles 46 in the axial direction AR. The supporting portion 50 also has a radially inner edge portion 54 that faces a rotor portion 56 of the gas turbine 10 when the brush seal 40 is in an assembled state. By way of example, the rotor portion 56 may be connected to a shaft 28 or to a shaft 30 of the gas turbine 10 (FIG. 1).

Starting from the radially inner edge portion 54, the supporting portion 50 has a radial supporting-portion length SL together with a substantially constant axial supporting-portion width SB. In this case, the supporting-portion length SL is greater than the supporting-portion width SB by at least a factor of four. As a result, a support ring structure 44 is provided that does not cause critical damage to the rotating component or rotor portion 56 if any rubbing against the rotor portion 56 occurs. In other words, the support ring structure 44 is configured to be significantly thinner at its radially inner supporting portion 50 in order to ensure that the damage to the rotor portion 56 is minimized in the event of rubbing. Despite this minimized axial supporting-portion width SB compared with known support rings, in conventional areas of operation of a gas turbine the support ring structure takes on the sealing action and also the supporting action for the bundle of bristles 46.

A transitional portion 58 adjoins the supporting portion 50 radially on the outside and has at least one curve contour 60 that diverges from the radial direction RR. In the example in FIG. 2, the two curved contours 60 have a convex and a concave curvature, respectively, formed one after the other.

In this case, the transitional portion 58 has an axial transitional width UB that is greater than the supporting-portion width SB. In particular, the axial transitional width UB increases constantly in the radial direction RR in the example in FIG. 2. It can also be seen in FIG. 2 that the supporting portion 50, the transitional portion 58, and the basis portion 48 of the support ring structure 44 are formed in one piece. In particular, FIG. 2 shows a support ring structure 44 that is manufactured either as a turned part or additively. The division of the support ring structure 44 into the supporting portion 50, the transitional portion 58, and the basis portion 48 is qualitatively indicated by the dash-dot lines in FIG. 2.

It can also be seen in FIG. 2 that the rotor portion 56 surrounded by the brush seal 40 has, in a rubbing region 62 facing the brush seal, a radial rotor thickness RDA that is greater than the radial rotor thickness RDN outside the rubbing region 62. Enlarging the rotor thickness in this way is optional and brings the advantage whereby the wall thickness RDA of the rotor portion 56 is greater in the rubbing region 62 so that the rotor is designed to be more robust against any potential rubbing by the supporting portion 50.

FIG. 2 also shows another optional feature of the rotor portion 56. The rotor portion 56 may have a coating 64, located radially on the outside, in the rubbing region 62.

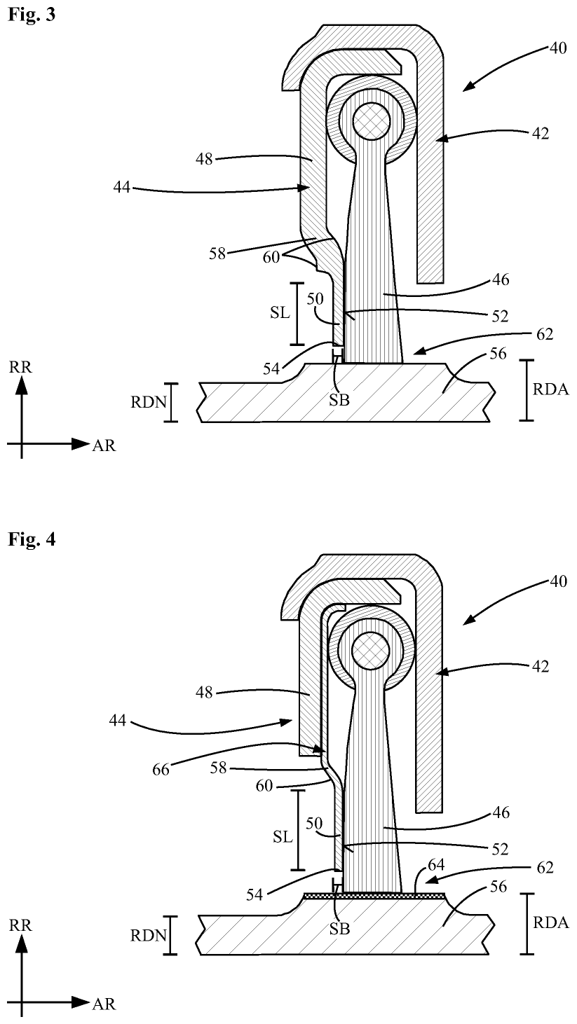

It should be noted that the greater radial thickness or wall thickness RDA of the rotor portion 56 in the rubbing region 62 and the coating 64 may be provided in combination, each by themselves, or not at all. This applies to the example in FIG. 2 and also to the examples in FIGS. 3 and 4 to be described below.

FIG. 3 is a schematic sectional view of a further example of a brush seal 40. The brush seal 40 comprises a cover ring structure 42, which can also be referred to simply as a cover ring 42. In addition, the brush seal 40 has a support ring structure 44, which in simpler terms can also be referred to as a support ring. A bundle of bristles 46 is arranged or received between the cover ring structure 42 and the support ring structure 44 in the axial direction AR.

In this example too, the support ring structure 42 has a basis portion 48 arranged radially on the outside and a supporting portion 50 arranged radially on the inside. The supporting portion 50 has a supporting surface 52 that faces the bundle of bristles 46 and supports the bundle of bristles 46 in the axial direction AR. The supporting portion 50 also has a radially inner edge portion 54 that faces a rotor portion 56 of the gas turbine 10 when the brush seal 40 is in an assembled state. By way of example, the rotor portion 56 may be connected to a shaft 28 or to a shaft 30 of the gas turbine 10 (FIG. 1).

In this example too, starting from the radially inner edge portion 54, the supporting portion 50 has a radial supporting-portion length SL together with a substantially constant axial supporting-portion width SB. In this case, the supporting-portion length SL is greater than the supporting-portion width SB by at least a factor of four. As a result, a support ring structure 44 is provided that does not cause critical damage to the rotating component or rotor portion 56 if any rubbing against the rotor portion 56 occurs. In other words, the support ring structure 44 is configured to be significantly thinner at its radially inner supporting portion 50 in order to ensure that the damage to the rotor portion 56 is minimized in the event of rubbing. Despite this minimized axial supporting-portion width SB compared with known support rings, in conventional areas of operation of a gas turbine the support ring structure takes on the sealing action and also the supporting action for the bundle of bristles 46.

A transitional portion 58 adjoins the supporting portion 50 radially on the outside and has at least one curve contour 60 that diverges from the radial direction RR. In the example in FIG. 3, the two curved contours 60 have a convex and a concave curvature, respectively.

In this case, the transitional portion 58 has an axial transitional width UB that is greater than the supporting-portion width SB. In particular, the axial transitional width UB increases constantly in the radial direction RR in the example in FIG. 3. It can also be seen in FIG. 32 that the supporting portion 50, the transitional portion 58, and the basis portion 48 of the support ring structure 44 are formed in one piece. In particular, FIG. 3 shows a support ring structure 44 that is manufactured as a formed sheet metal part. The division of the support ring structure 44 into the supporting portion 50, the transitional portion 58, and the basis portion 48 is qualitatively indicated by the dash-dot lines in FIG. 3.

The example in FIG. 3 also shows the rotor portion 56 having a greater rotor thickness or wall thickness RDA in the rubbing region 62, albeit without a coating.

FIG. 4 shows a similar example of a brush seal 40 to that in FIG. 3. Unlike the single-piece configuration of the support ring structure 44 in FIG. 3 (and also FIG. 2), the support ring structure 44 in FIG. 4 is configured in multiple parts, in particular two parts. In this case, the supporting portion and the transitional portion 58 are configured as a single-piece supporting element 66 that is connected to the basis portion 48 of the support ring structure. The basis portion 48 and the supporting element 66 are each made from formed sheet metal parts. Otherwise, reference should be made to the above description of FIGS. 2 and 3 for the other reference signs shown in FIG. 4; said description is also valid for the example of the brush seal 40 in FIG. 4 and applicable analogously.

For all the examples of brush seals 40 disclosed above with reference to FIGS. 2 to 4, the following applies in relation to the supporting portion 50 together with its supporting-portion length SL and its supporting-portion width SB: the supporting-portion length SL is greater than the supporting-portion width SB by at most a factor of twenty. By way of example, the supporting-portion length SL may be approximately 1 mm to 4 mm, in particular 2 mm to 3 mm, and the supporting-portion width SB may be approximately 0.1 mm to 0.8 mm, in particular 0.2 mm to 0.6 mm.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Aircraft gas turbine
12 Fan
14 Duct
16 Compressor
18 Inner casing
20 Combustor
22 Turbine
24 High-pressure turbine
26 Low-pressure turbine
28 Hollow shaft
29 High-pressure compressor
30 Shaft
31 Stator vane ring
32 Low-pressure compressor
33 Exhaust nozzle
34 Turbine center frame
36 Radially outer region
38 Annular space
40 Brush seal
42 Cover ring structure
44 Support ring structure
46 Bundle of bristles
48 Basis portion
50 Supporting portion
52 Supporting surface
54 Edge portion
56 Rotor portion
58 Transitional portion
60 Contour
62 Rubbing region
64 Coating
66 Supporting element
AR Axial direction
RR Radial direction
RDA Rotor thickness or wall thickness
RDN Rotor thickness or wall thickness
SB Supporting-portion width
SL Supporting-portion length
UB Transitional width

1. A brush seal for a gas turbine, the brush seal comprising:
a support ring structure; and
at least one bundle of bristles that is arranged in an axial direction on the support ring structure,
wherein the support ring structure has an inside, an outside, a basis portion arranged radially on the outside, and a supporting portion arranged radially on the inside,
wherein the supporting portion has a supporting surface that faces the bundle of bristles and supports the bundle of bristles in the axial direction,
wherein the supporting portion has a radially inner edge portion that is configured to face a rotor portion of the gas turbine when the brush seal is in an assembled state, and
wherein starting from the radially inner edge portion, the supporting portion has a radial supporting-portion length together with a substantially constant axial supporting-portion width, the supporting-portion length being greater than the supporting-portion width by at least a factor of four.

2. The brush seal according to claim 1, wherein a transitional portion adjoins the supporting portion radially on the outside and has at least one curve contour that diverges from the radial direction.

3. The brush seal according to claim 2, wherein the transitional portion has an axial transitional width that is greater than the supporting-portion width.

4. The brush seal according to claim 3, wherein the axial transitional width increases in the radial direction either constantly or discretely.

5. The brush seal according to claim 2, wherein the supporting portion, the transitional portion, and the basis portion of the support ring structure are formed in one piece.

6. The brush seal according to claim 1, wherein the supporting portion and the transitional portion are configured as a single-piece supporting element that is connected to the basis portion of the support ring structure.

7. The brush seal according to claim 1, wherein the supporting-portion length is greater than the supporting-portion width by at most a factor of twenty.

8. The brush seal according to claim 1, wherein the supporting-portion length is approximately 1 mm to 4 mm, and wherein the supporting-portion width is approximately 0.1 mm to 0.8 mm.

9. The brush seal according to claim 1, further comprising a cover ring structure, the bundle of bristles being received between the cover ring structure and the support ring structure in the axial direction.

10. The gas turbine, comprising at least one brush seal according to claim 1 surrounding a rotor portion of the gas turbine.

11. The gas turbine according to claim 10, wherein the rotor portion surrounded by the brush seal has, in a rubbing region facing the brush seal, a radial rotor thickness that is greater than the radial rotor thickness outside the rubbing region.

12. The gas turbine according to claim 11, wherein the rotor portion has a coating, located radially on the outside, in the rubbing region.

13. The brush seal according to claim 1, wherein the supporting-portion length is approximately 2 mm to 3 mm, and the supporting-portion width is approximately 0.2 mm to 0.6 mm.
